(19) United States
(12) Patent Application Publication
(10) Pub. No.: US 2007/0290789 A1
(43) Pub. Date: Dec. 20, 2007

(54) Intelligent Interactive Lock and Locking System

(76) Inventors: Erez Segev, Nofit (IL); Shmuel Gan, Qiriat Ata (IL)

Correspondence Address: PEARL COHEN ZEDEK LATZER, LLP, 1500 BROADWAY 12TH FLOOR, NEW YORK, NY, 10036, US

(21) Appl. No.: 11/631,840

(22) PCT Filed: Jul. 6, 2005
(86) PCT No.: PCT/IL05/00715

§ 371 Date: Jul. 5, 2007

Related U.S. Application Data
(60) Provisional application No. 60/585,089, filed on Jul. 6, 2004.

(51) Int. Cl. G05B 19/00

(52) U.S. Cl. 340/5.6

(57) ABSTRACT

An intelligent lock comprises a mechanical element operative to provide two lock position upon a proper actuation, and an electromechanical (EM) trigger separate from and coupled to the mechanical element and operative to control the actuation. When included in an intelligent locking system, the lock is remotely controllable through a monitoring and control unit, operative to relay commands to the EM trigger.

### FIELD OF THE INVENTION

The present invention relates in general to locking systems and more particularly to intelligent locking systems comprising at least one electromechanical component.

### BACKGROUND OF THE INVENTION

Known traditional lock systems are based on stand-alone, hard to access mechanical units (usually made from steel), each having a matching key that enables locking or unlocking a lock unit. Any person who holds a matching key can open the lock.

Stand-alone electronic lock systems are also known, and widely used in places like hotels, office buildings, security locations with restricted access, etc. Some systems of this type use an electronic card (usually a credit card type), which includes the information required to access a specific lock. The information is stored on the electronic card itself. The card is entered into or swiped through the lock, enabling or disabling (e.g. opening or closing) the lock. Other electronic lock systems may include biometric type cards.

Electrical locking systems are also known. US Patent Application No. 20020099945 by G. McLintock et al. discloses a door access control and key management system, in which a number of doors and door users are involved. The application discusses in its background the state of the art and lists its problems and disadvantages. The system disclosed in 20020099945 comprises a door/key administering system and a door lock/control assembly mounted on each door, which are communicatively interconnected with each other via a communications network. The door/key administering system serves to store a key unique to each of the users, store an identification code unique to each of the doors, and assign access authorization to at least one user for each door. The door lock/control assembly serves to read the key presented by the user, verify that the key has access authorization, and operate the door in response to the authorization for access. Each user can gain access to the doors authorized to the user with a unique key and each door can provide access to the user or users assigned thereto. Since the lock system in McLintock's application is purely electrical, it is prone to power failures.

Existing dual-element locks that combine electronic features with mechanical parts (i.e. a cylinder) in one unit (“unitary” design) are also known, an example being the “CLIQ” cylinder manufactured by Multilock Technologies Ltd., P.O.B 637, Yavne 81104, Israel . A major disadvantage of such combined units is that physical damage to the mechanical part damages the electronic part too. The key in such combined units supplies the power to the cylinder, and the electrical contact is prone to disruption. Another major disadvantage of “single part” unitary locks, either electrical, mechanical, or combined electromechanical (EM), is that tampering may disable the lock functionality.

In view of the disadvantages presented by such locks, it would be advantageous to have a sturdier, safer lock, which is less prone to tampering. Moreover, it would be advantageous to provide a lock and locking system having high security, high break-in protection, real-time key management and control, real time interactivity capability and real time entry control.

### SUMMARY OF THE INVENTION

The present invention discloses an intelligent lock and locking system with novel features, which provide significant advantages non-existent in prior art locks and locking systems. In particular, the invention discloses a “two-part” mechanical lock in which the locking mechanism is actuated by two separate elements: a mechanical element (cylinder) and an EM element (also referred to as “trigger”). The EM trigger is operative to communicate with a monitoring and control unit that enables to monitor a lock status and provides controlled access to the lock. In this disclosure, “intelligent lock system” refers in a restricted sense to the intelligent lock and the monitoring and control unit, and in a larger sense to an architecture that enables remote operation of the intelligent lock by at least one remote user.

In some embodiments, the intelligent lock is a stand-alone lock that communicates with remote users/control entities through a wireless communication system. In other embodiments, the intelligent lock is incorporated in a door.

According to the present invention there is provided an intelligent lock comprising a mechanical element operative to provide two lock positions upon a proper actuation; and an electromechanical trigger separate from and coupled to the mechanical element and operative to control the actuation.

According to one feature of the intelligent lock of the present invention, the mechanical element is a cylinder actuable by a smart key, and the two positions are an open lock position and a closed lock position.

According to another feature of the intelligent lock of the present invention, the EM trigger control is responsive to information relayed by the smart key.

According to yet another feature of the intelligent lock of the present invention, the EM trigger control is responsive information is relayed by at least one sensor external to the lock.

According to yet another feature of the intelligent lock of the present invention, the information relay and the trigger control are effected through a monitoring and control system coupled to both the mechanical element and the EM trigger.

According to yet another feature of the intelligent lock of the present invention the relay is wireless.

According to yet another feature of the intelligent lock of the present invention, the information includes at least one lock status parameter and wherein the control includes at least one command to change the lock status parameter.

According to yet another feature of the intelligent lock of the present invention, the lock is coupled to a door, wherein the information includes at least one door status parameter and wherein the control includes at least one command to change the door status parameter.

According to the present invention there is provided an intelligent lock comprising a mechanical cylinder operative to receive a smart key; an electromechanical trigger physically separate from the cylinder; and a mechanism for controlling a position of the trigger based on inputs provided by the smart key or a separate lock event generator, whereby the trigger position determines a lock status.

According to one feature of the intelligent lock of the present invention, the smart key includes a unique identification element used in the input.

According to another feature of the intelligent lock of the present invention, the mechanism for controlling the trigger position includes a mechanism for relaying commands from a monitoring and control unit.

According to yet another feature of the intelligent lock of the present invention, the mechanism for relaying commands includes electrical connections to the monitoring and control unit.

According to yet another feature of the intelligent lock of the present invention, the mechanism for relaying commands includes wireless connections to the monitoring and control unit.

According to the present invention there is provided an intelligent lock system comprising an intelligent lock comprising a mechanical element operative to provide two lock positions upon a proper actuation; and an EM trigger separate from and coupled to the mechanical element and operative to control the actuation, and a monitoring and control unit communicatively coupled to the EM trigger and used to provide actuation commands.

According to one feature of the intelligent lock system of the present invention, the intelligent lock is included in a door.

According to another feature of the intelligent lock system of the present invention, the door is selected from the group of a home door, a safe door and an armored car door.

According to yet another feature of the intelligent lock system of the present invention, the system further comprises communication means for communication between the monitoring and control unit and at least one remote user.

According to yet another feature of the intelligent lock system of the present invention, the communication means include wireless means.

According to yet another feature of the intelligent lock system of the present invention, the actuation commands are generated by the at least one remote user.

### BRIEF DESCRIPTION OF THE DRAWINGS

The present invention is described herein by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the present invention. In this regard, no attempt is made to show structural details of the present invention in more detail than is necessary for a fundamental understanding of the invention, the description taken with the drawings making apparent to those skilled in the art how the several forms of the invention may be embodied in practice. Identical structures, elements or parts which appear in more than one figure are preferably labeled with a same or similar number in all the figures in which they appear. In the drawings:

FIG. 1 shows schematically details of an exemplary intelligent two-part lock unit A) details of the unit, cylinder, smart key and trigger; B) the unit in a locked (closed) position; and C) the unit in an open position;

FIG. 2 shows an a door incorporating the intelligent lock of the present invention;

FIG. 3A shows more detailed view of a lock interface module (LIM), functionally coupled to an intelligent lock in a door;

FIG. 3B shows a communication and control architecture according to the present invention.

FIG. 3C shows further entities that may be included in a communication and control architecture according to the present invention

### DETAILED DESCRIPTION OF THE PREFERRED EMBODIMENTS

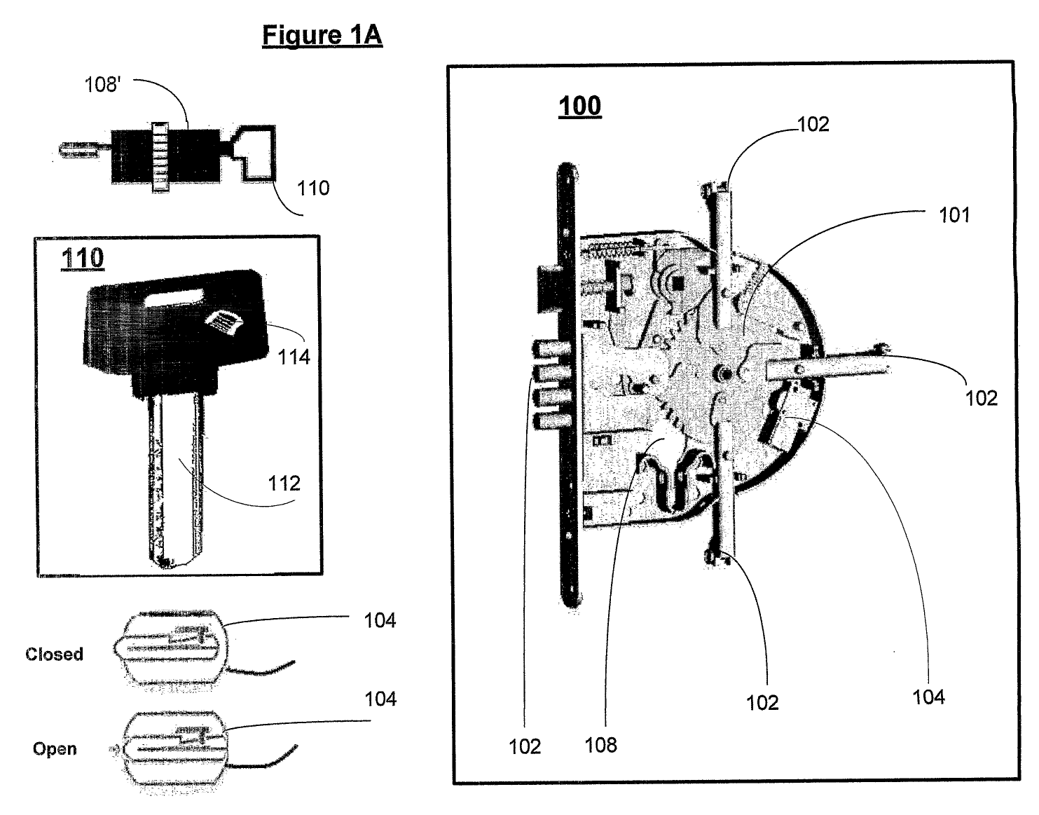

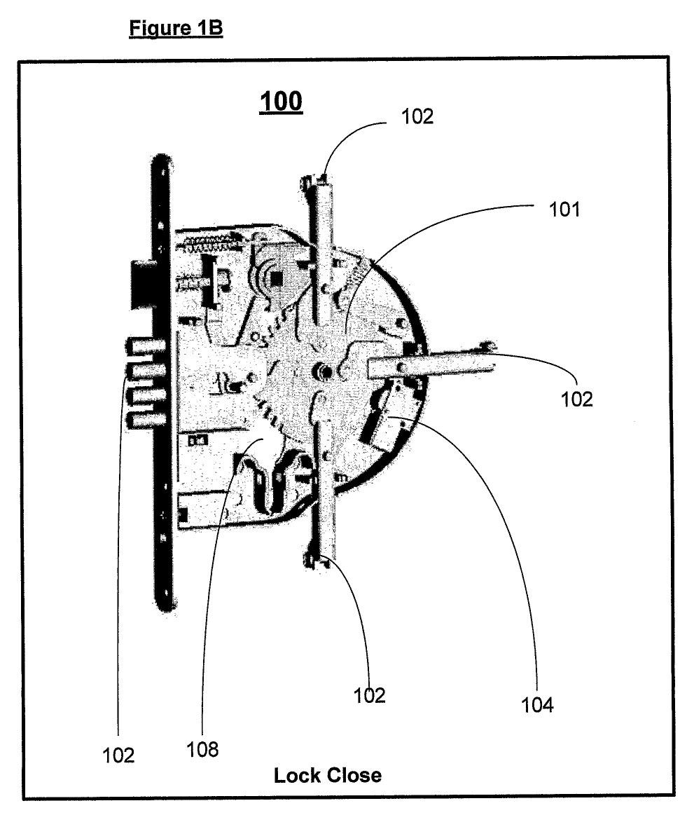

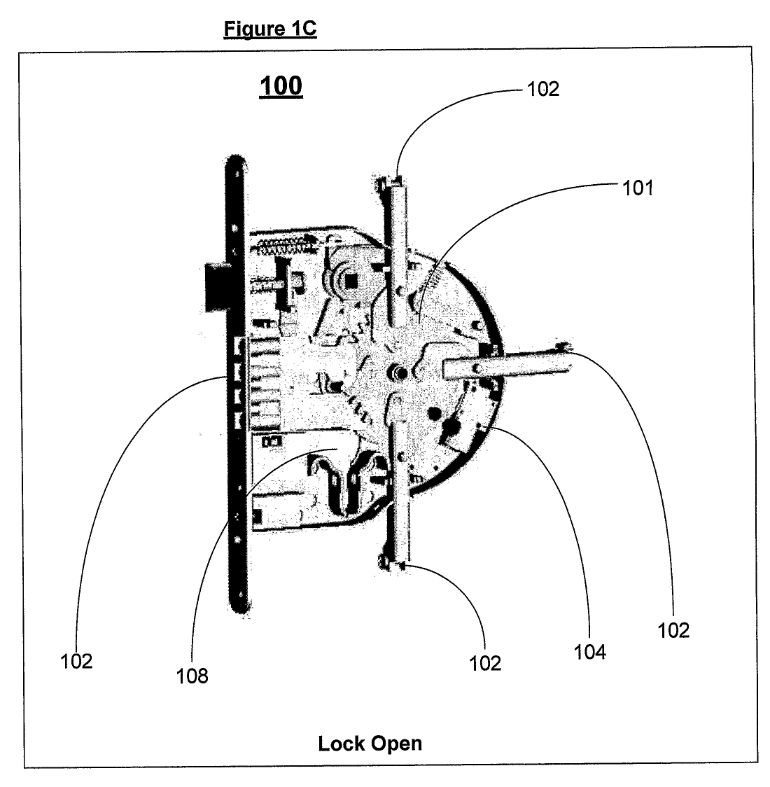

FIG. 1 shows schematically details of an exemplary intelligent two-part EM lock unit (or simply “intelligent lock”) 100, which in this example is based on a typical mechanical lock. In FIG. 1A, lock 100 comprises a locking mechanism 101 operative to move and position locking bars (or levers) 102 in at least two positions: open and closed. Lock 100 further comprises an electromagnetic element (“trigger”) 204 operative to engage mechanism 101. Trigger 104 may exemplarily be an electrically actuated element such as the “Active Latch” by Servocell Ltd, larlow, Essex CM20 2BN, UK. The trigger is shown schematically in FIG. 1A in more detail in two positions: in a locked position and in an open position. It will be apparent to one skilled in the art that the EM trigger may be actuated by other means (e.g. magnetically, piezo-electrically, etc.), directly through a physical link or remotely, e.g. by wireless means. Lock 100 further comprises a cylinder hole 108 into which a cylinder 108′ is inserted. The cylinder may be any regular mechanical cylinder or mechanical lock opening mechanism known in the art. Cylinder 108′ is operative to mechanically engage locking mechanism 101, through, for example, the action of a key 110 with a shaft 112. In a preferred embodiment, key 110 is a “smart” key that comprises a unique identification (ID) element such as a radio frequency identification (RFID) chip 214. Smart keys of this type are known, and exemplarily include “immobilizer” type car keys manufactured by Toyota Corp, Mercedes Corp., etc. The use of an RFID chip removes the need for an independent power source such as a battery for powering the smart key.

Advantageously and in contrast with prior art, the intelligent lock of the present invention comprises two separate parts that are required to work in coordination to allow a lock status change. The two parts are a mechanical part (the cylinder) and an electro-mechanical part (the trigger). Both are designed to operatively engage the locking mechanism. The tampering with one (e.g. the cylinder) does not affect the other.

FIG. 1B shows the lock in a closed position, in which the trigger engages the locking mechanism and prevents it from moving the bars, even if a key inserted in the cylinder attempts to do so. FIG. 1C shows the lock in an open position in which the trigger is disengaged from the locking mechanism, which is now free to move the bars into either open or closed position.

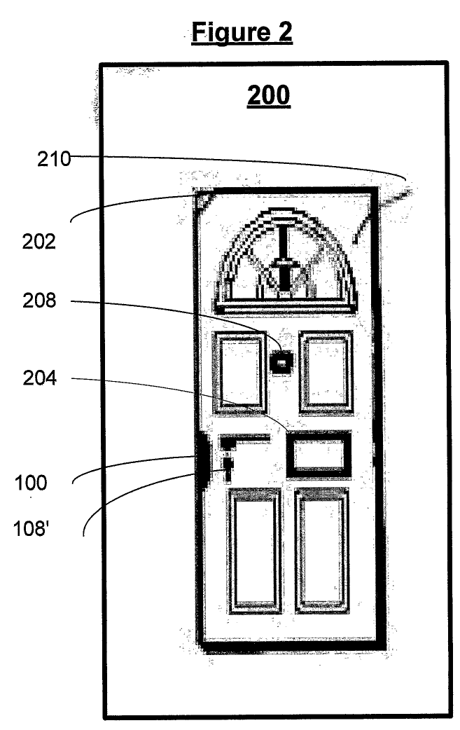

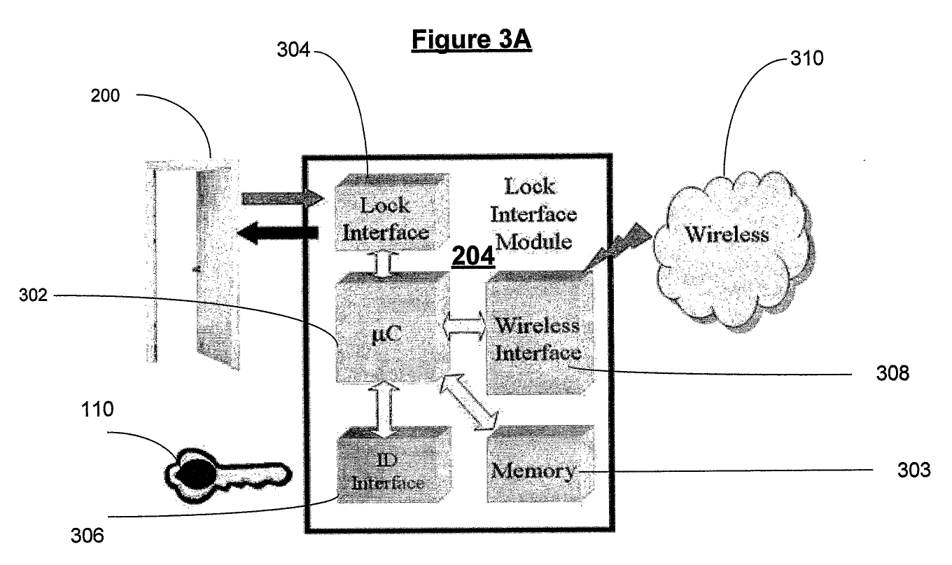

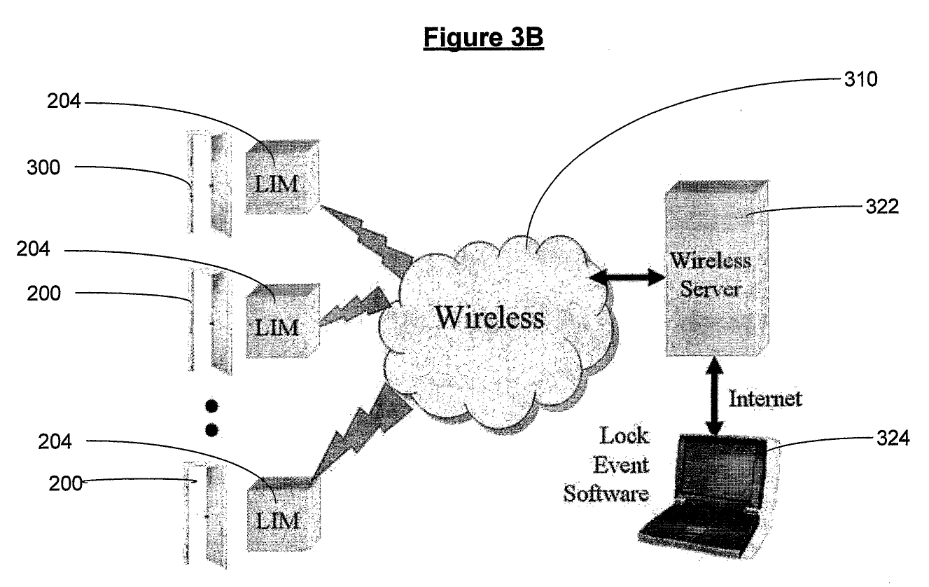

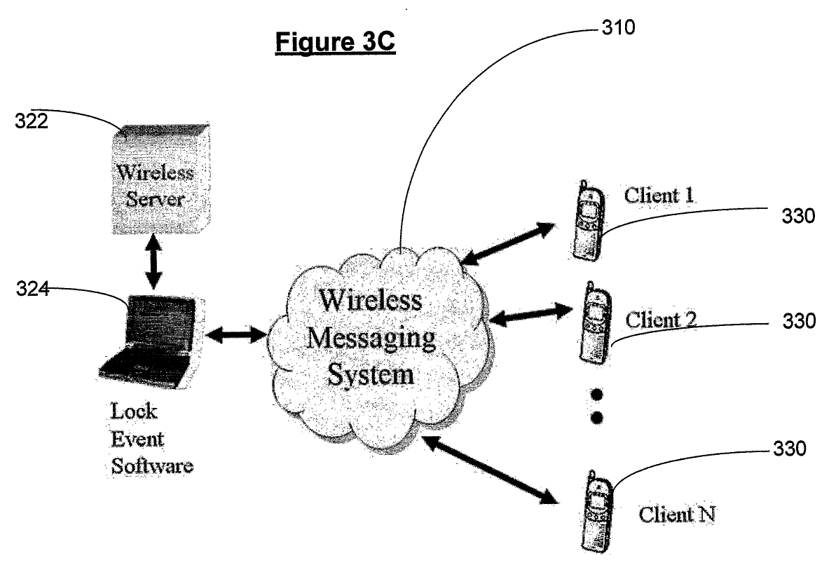

FIG. 2 shows schematically a door 200 in which the intelligent lock of the present invention may be included to provide an “intelligent” door. Throughout the description and claims, an “intelligent door” refers to all types of doors for access thereto to be controlled, including building entrance doors or interior doors, private house doors, vehicle doors, and safe doors. An “intelligent lock” refers to all types of door locks as well as locks for other devices such as bicycles, padlocks, safes, Brinks-type armored cars, etc. An intelligent lock may thus not necessarily be included in a door, but may be used in other entities. Moreover, this invention is not limited to the doors and locks noted above. Door 200 comprises in addition to lock 100 a sensor 202 for sensing a door status (e.g. “door open” or “door closed”), a monitoring and control unit (also referred to as lock interface module or LIM) 204 for monitoring the door and/or lock status (i.e. “lock open” or “lock closed”) and for relaying commands to the EM trigger. Unit 204 further comprises subunits (modules) described in more detail in FIG. 3A. Door 200 further comprises an optional viewing mechanism (i.e. a TV or video camera) 206 and an electrical connection 208 to relay electrical power to the various electrical and electronic units in the door. For example, the smart key may be operable by electrical induction, without a need for a battery. Similarly, the trigger may powered by an external power source.

LIM 204 typically communicates with the EM trigger by electrical means (wired or wireless) and with the smart key by wireless means. The trigger is operative to receive commands (instructions) from unit 204 and to act upon such commends to engage or disengage mechanism 101. This action is independent of and separate from the engaging/disengaging action of cylinder 108′, which is actuated by the key. As mentioned and emphasized, the physical separation of the EM trigger from the cylinder provides unique advantages in terms of functionality and reliability as described above.

FIG. 3A shows more detailed view of a LIM 300 functionally coupled to an intelligent lock in a door 200. LIM 300 comprises a microcontroller 302 for controlling all actions in the system; a memory 303 for storing data and programs; a lock interface 304 that includes all drivers needed for communication with the EM locking actions; an ID interface 306 which communicates with the ID in the key; and a wireless interface 308, interconnected as shown. In the case where the lock is attached to a door (as in FIG. 2) the following conditions are exemplarily monitored by the LIM unit: “door open”, “door close”, “lock open” and “lock close”. A change in the above conditions is referred to as an “event”. The LIM unit communicates and reports the events to a remote site, using a wireless connection, e.g. a wireless network 310. The control functionality of the lock is achieved using the unique identification device (RFID) embedded within key 110. The ID interface is able to identify the embedded ID in the key and deliver the information to the LIM unit. The LIM unit then enables or disables the lock using the lock interface and according to a predefined set of rules for each ID.

Endowed with transmitting/receiving functions of an LIM, the intelligent lock may be remotely controlled and activated through a variety of means. FIG. 3B shows a communication and control architecture comprising a plurality of LIMs residing in respective doors, the LIMs communicating through wireless network 310, a wireless server 322 and the Internet with a user, represented by a PC 324. The user may run a lock event software that receives inputs from each LIM and provides commands to the intelligent lock through the LIM. FIG. 3C shows a further expansion of the architecture in FIG. 3B, where the the PC (and lock event software) is communicating with a plurality of remote clients 330 through a wireless messaging system. In general, it will be apparent to one skilled in the art that the operation of an intelligent lock of the present invention may be controlled and effected remotely through a communications architecture that includes various communication means and various user devices. An exemplary general communications architecture that may be used in this context will be similar to that described in US Patent Application No. 20020099945.

A major advantage of any of the architectures in FIGS. 3B and 3C is that the intelligent, two-part EM lock is operative to communicate interactively in real-time with external entities (users, central control facility, etc.). The lock is enabled to produce events based on a user-specific prearranged sequence or plan or user-specific profile. This in turn provides high security, high break-in protection, real-time key management and control, real time interactivity capability and real time entry control. As mentioned, another unique major advantage emanates from the physical separation of the EM trigger and the cylinder, in contrast with the situation in existing dual-element locks that combine electronic features with mechanical parts (e.g. the cylinder) in one unit, for example the “CLIQ” cylinder manufactured by Multilock Technologies. The present invention ensures that the EM trigger remains undamaged by any attempt to tamper with the mechanical cylinder.

Returning now to FIG. 1, the intelligent lock of the present invention has extended functionalities. For example, it may generate events and relay information and receive information and commands. In particular, external users may pass requests through the server to open or close a particular door at a particular time or time frame. Requests may also include denying access to certain users identifiable by coded keys, for example in case a key is reported as stolen.

In general use, a smart key is inserted in the cylinder to open or close the lock. Information on the smart key, obtained through its RFID, is relayed to the LIM, preferably in an encoded form through any of the communication means and schemes described in FIGS. 3B and 3C. The LIM then instructs the trigger to act accordingly and perform one of two operations: respond to the key action or block it. Exemplarily, if the key is authorized to open a locked door, the authorization is relayed to the trigger which responds by retracting from the locking mechanism. If the key is not authorized (e.g. if stolen), the trigger is notified of its non-authorized status and refuses to retract (blocks the key actuation).

In more detail, a lock event software located typically in a user device such as PC 324 analyses data received through wireless server 322. According to a predefined set of rules (example below), the software decides to transmit messages to a specific client, exemplarily a phone 330. Example of rules may include:

| Person | Time | Access | Report |
|---|---|---|---|
| Home owners | At all times | Always | No |
| Child | At all times | Always | Yes |
| Cleaning | Monday | Only during the | Yes |
| | 0800-1500 | allowed time | |

### ADVANTAGES OF THE INVENTION

The intelligent lock system has advantages over traditional locks, some of which are:
1. Real time remote monitoring: The user is able to get on-line messages directly to his/hers messaging device (such as Cellular phone, pager, e-mail, etc.). The messages include data such as time, events (door open, lock closed), etc.
2. Real-time controlled access: The user can enable/disable the lock in real time from a remote location, using communication devices such as Internet connected PCs or cellular phones. In the case where the mechanical keys includes a unique ID device, the user can enable or disable the lock for a specific key holder (identifiable by the embedded ID device within the key)
3. Ease of use: In the case of a lost key, the user of the intelligent locking system can handle the condition in an easier way than in traditional lock systems In contrast with the case of a traditional lock, in which the lock and all the matching keys need to be replaced, in the intelligent locking system of the present invention, losing a key means disabling only the specific ID which belongs to the lost key. A new key with a new ID can be added to the system and there is no need to replace the lock and the other keys.

All patents and patent applications mentioned in this specification are herein incorporated in their entirety by reference into the specification, to the same extent as if each individual patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. An intelligent lock comprising:
a. a mechanical element operative to provide two lock positions upon a proper actuation; and
b. an electromechanical (EM) trigger separate from and coupled to the mechanical element and operative to control the actuation.

2. The intelligent lock of claim 1, wherein the mechanical element is a cylinder actuable by a smart key, and wherein the two positions are an open lock position and a closed lock position.

3. The intelligent lock of claim 2, wherein the EM trigger control is responsive to information relayed by the smart key.

4. The intelligent lock of claim 2, wherein the EM trigger control is responsive information is relayed by a sensor external to the lock.

5. The intelligent lock of claim 2, wherein the information relay and the trigger control are effected through a monitoring and control system coupled to both the mechanical element and the EM trigger.

6. The intelligent lock of claim 2, wherein the relay is wireless.

7. The intelligent lock of claim 2, wherein the information includes at least one lock status parameter and wherein the control includes at least one command to change the lock status parameter.

8. The intelligent lock of claim 2, wherein the lock is coupled to a door, wherein the information includes at least one door status parameter and wherein the control includes at least one command to change the door status parameter.

9. An intelligent lock comprising:
a. a mechanical cylinder operative to receive a smart key;
b. an electromechanical trigger physically separate from the cylinder; and
c. a mechanism for controlling a position of the trigger based on inputs provided by the smart key or a separate lock event generator;
whereby the trigger position determines a lock status;

10. The intelligent lock of claim 9, wherein the smart key includes a unique identification element used in the input.

11. The intelligent lock of claim 9, wherein the mechanism for controlling the trigger position includes a mechanism for relaying commands from a monitoring and control unit.

12. The intelligent lock of claim 11, wherein the mechanism for relaying commands includes electrical connections to the monitoring and control unit.

14. The intelligent lock of claim 11, wherein the mechanism for relaying commands includes wireless connections to the monitoring and control unit

15. An intelligent lock system comprising:
a. an intelligent lock comprising a mechanical element operative to provide two lock positions upon a proper actuation; and an electromechanical (EM) trigger separate from and coupled to the mechanical element and operative to control the actuation; and
b. a monitoring and control unit communicatively coupled to the EM trigger and used to provide actuation commands.

16. The intelligent lock system of claim 15, wherein the intelligent lock is included in a door.

17. The intelligent lock system of claim 16, wherein the door is selected from the group of a home door, a safe door and an armored car door.

18. The intelligent lock system of claim 15, further comprising communication means for communication between the monitoring and control unit and at least one remote user.

19. The intelligent lock system of claim 19, wherein the communication means include wireless means.

20. The intelligent lock system of claim 19, wherein the actuation commands are generated by the at least one remote user.
